(19) United States
(12) Patent Application Publication
(10) Pub. No.: US 2015/0236456 A1
(43) Pub. Date: Aug. 20, 2015

(54) Easy Plug

(71) Applicant: Pedro Arroyo Sosa, Kansas City, KS (US)

(72) Inventor: Pedro Arroyo Sosa, Kansas City, KS (US)

(21) Appl. No.: 14/617,541

(22) Filed: Feb. 9, 2015

Related U.S. Application Data
(60) Provisional application No. 61/941,163, filed on Feb. 18, 2014.

(51) Int. Cl. H01R 24/28

(52) U.S. Cl. CPC H01R 24/28

(57) ABSTRACT

An improved electrical plug uses a provided liner attacher for electrical lines having a hook coupled into a cavity, the hook having and arm for transmitting motion therefore the hook coupling into the cavity pressing an electrical connector, also is provided a locking and unlocking mechanism to secure a plug's cover to an electrical connectors holder, having a contrived of passages and slopes for looking and unlocking a tooth coupled to the component to be attached, and a space adjuster mechanism is provided to fasten up a cable, having a plurality of components concentrically and uniformly arranged for closing or opening a hole to fasten up a cable among them, including components with a plurality of teeth engaged, to keep up the tension among the components adjusting the hole's size. All of this achived without the functionality of traditional screws.

This is an update of above related invention claiming priority of related application U.S. 61/941,163 filled Feb. 18, 2014

### BACKGROUND OF THE INVENTION

1. Field of the invention

The invention relates to an electrical plug the kind used on electrically operated equipment, particularly to improvements into the components and the way all the components within the plug are attached and secured without the function of screws for this purpose.

2. Description of Related Art

Electrical plugs including on electrically operated equipment are well known in the art. AC power plugs and sockets are devices that allow electrically operated equipment to be connected to the primary alternating current power supply in a building. Plugs and sockets for portable appliances started becoming available in 1880s'.

Generally the plug is the movable connector attached to an electrically operated device's mains cable, and the socket is fixed on equipment or a building structure and connected to an energized electrical circuit. The plug has protruding prongs, blades, or pins (referred to as male) that fit into matching slots or holes (called female) in the sockets.

As electricity became a common method of operating labour-saving appliances, a safe means of connection to the electricity system other than using a light socket was needed. According to British Author John Mellanby the first plug and socket in England was introduced by T. T. Smith in 1883, and there were two-pin designs by 1885, one of which appears in the General Electric Company Ltd. Gustav Binswanger, a German immigrant who founded the (British) General Electric Company Ltd, obtained a patent (GB189516898) in 1895 for a plug and socket using a concentric (co-axial) contact system.

An early electrical plug and socket was invented by Harvey Hubbelll and patented in 1904. Hubbell's first design was a socket which screwed into a lamp holder (like the early lamp holder plugs), but with a separable plug with pins or blades (U.S. Pat. No. 774,250).

The German Schuko-system plug was patented by Albert Büttner in 1926. The current American version of the earthed plug, with two parallel blades and a round earthing pin, was invented by Philip F. Labre, while he was attending the Milwaukee School of Engineering. He was issued an US patent for an earthed socket and plug in 1928.

In the prior art, the most conventionals male and female electrical plugs replacements use on the electrical connectors wherein the wires are attached, a metal holder with a hole on its center to attaching the wires with screws; although this features of these kind of connections tend to satisfied the function, attaching the wires into these holders with the screws is difficult and it takes a considerably time depending of the model and design, further the most common plugs replacements use screws to keep the cord tightened and to keep the cover secured to the holder of the electrical connectors as well.

### SUMMARY OF THE INVENTION

The object of this invention is to provide within a plug, improved components eliminating the function of conventional screws. According to the characteristics of the invention a novelty line attacher is provided to attach each wire to each electrical connector within an electrical plug; a novelty locking and unlocking mechanism is provided to secure a plug's cover to the component holding the electrical connectors within the plug and a space adjuster mechanism is provided to keep a cord cable tightened firmly to the plug.

The line attacher includes a hook hanging into a line holder's cavity, the said hook having an elongated arm and the cavity of the said line holder matching at least part of the curvature of the hook, wherein the elongated arm transmitting a force to the hook, therefore the hook coupling into the line holder pressing the electrical connector and securing the electrical wire between.

The locking and unlocking mechanism includes, a holder with a complex of passages and slopes, wherein a tooth coupled to the component to be attached, passing through a main passage therefore locks behind a locking slope, then the said tooth can be operatively unlocked by climbing an unlocking slope and leading to an exit passage, then it can be returned to the main passage.

The space adjuster mechanism includes a concentrical flower consists on several movable petals being components concentrically and uniformly arranged, said petals pivotally coupled to a concentrical guide's slots and pivotally coupled to a motion transmitter's slots, said petals mounted one over another on their interior sides, said interior sides projected to the axis, wherein the motion transmitter is rotating the petals sliding on their interior sides one over the other adjusting the space among the interior sides, therefore pressing the cord cable among.

### BRIEF DESCRIPTION OF THE DRAWINGS

FIG. 1 is an elevational view of the line attacher coupled to the electrical connector.

FIG. 2 is an elevational partial view of the locking and unlocking mechanism.

FIG. 3 is an elevational complementary partial view of the locking and unlocking mechanism showing the electrical connectors' holder and the features of the tooth.

FIG. 4 is an elevational view of the concentrical guide.

FIG. 5 is an elevational view of the plurality of petals called the concentrical flower.

FIG. 6 is an elevational view of the motion transmitter.

FIG. 7 is an elevational view of the improved electrical plug. (this view is the one for the front page).

### DETAIL DESCRIPTION OF THE PREFERRED EMBODIMENTS

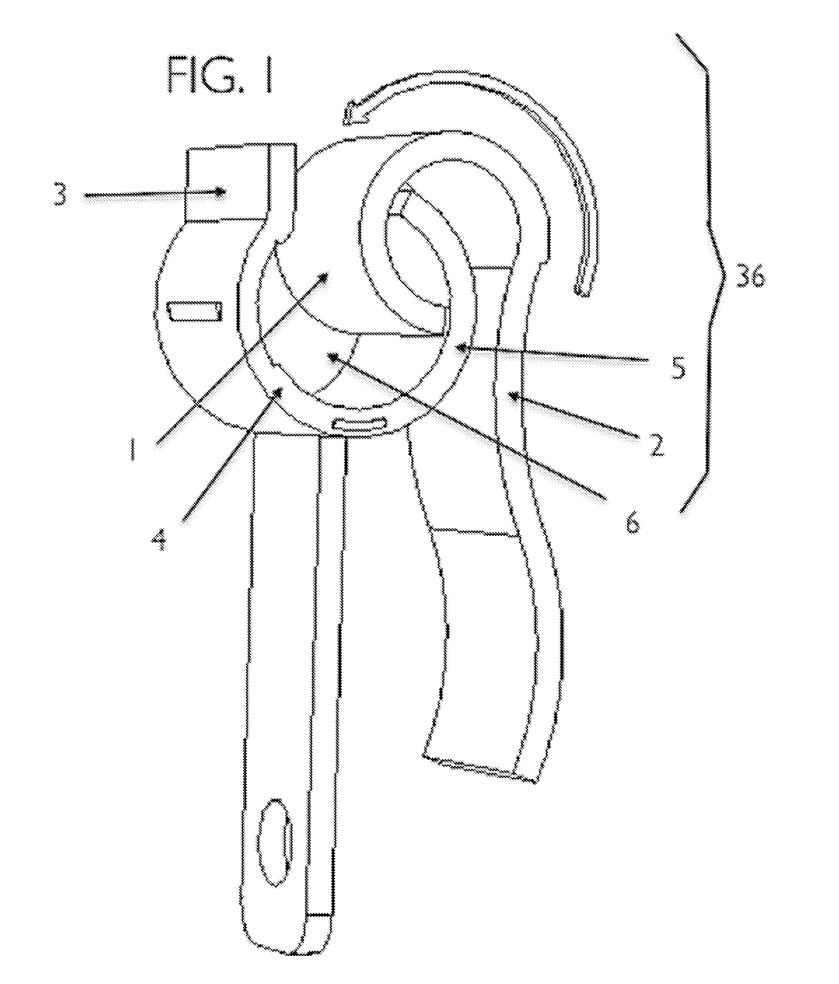

referring to the drawings there are shown improved components for an improved electrical plug 40 illustrated on FIG. 7 wherein the plug uses an improved line attacher 36 illustrated on FIG. 1 where a hook 1 hanging into a cavity 6, an elongated arm of the hook 2 is pushed or pulled up, therefore the hook 1 coupling into the cavity. 6 pressing the electrical connector 3. The elongation of the line holder 5 shows an alternative modification of the embodiment.

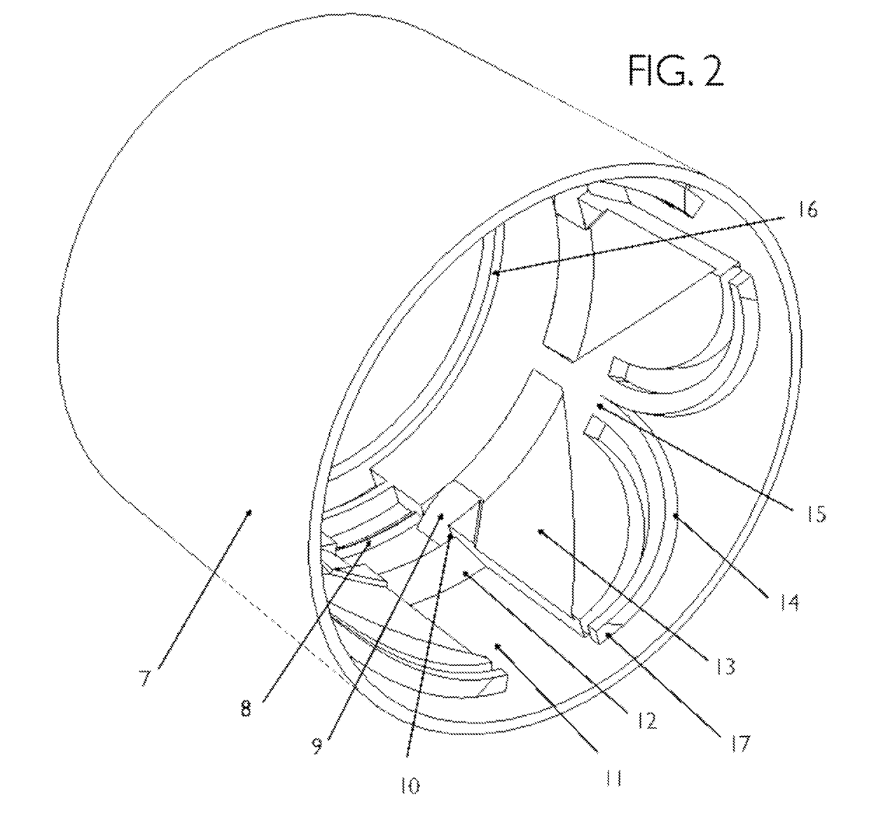

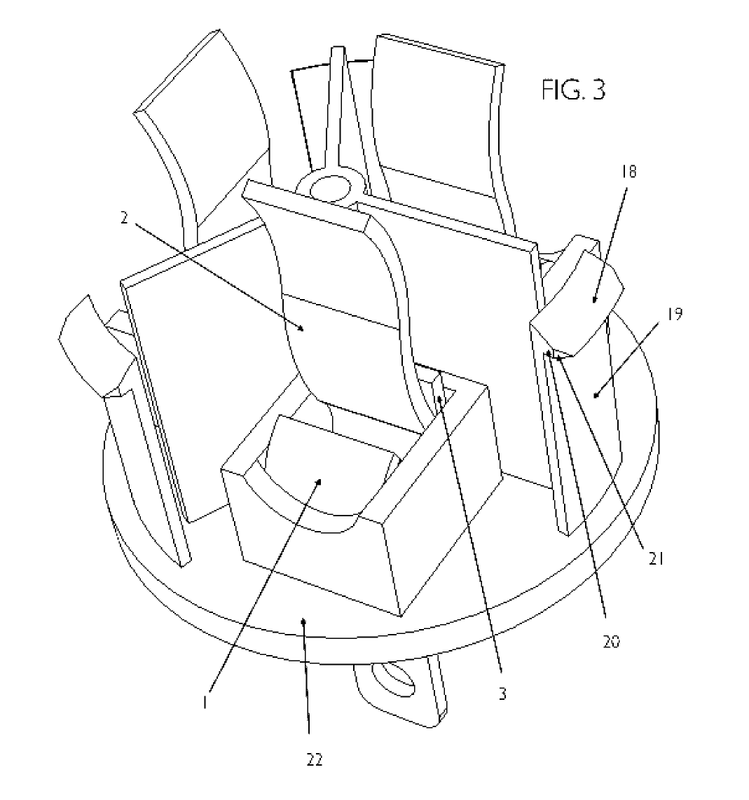

In FIG. 2 and FIG. 3 there is shown a locking and unlocking mechanism for attaching a plug's cover to an electrical connectors' holder 22, illustrated in FIG. 3, wherein a tooth 18 having an elongated body of a flexible material 19 and coupled to the electrical connectors' holder 22, is passing through a main passage 11 illustrated in FIG. 2, then climbing up a locking slope 12 is getting locked behind it, then it can be unlocked by turning it either left or right, climbing an unlocking slope 9 and getting out via an exit passage 13.

An optional unlocking preventer mechanism is shown in FIG. 2 and FIG. 3 as well, wherein the tooth 18 is illustrated in FIG. 3 has the sides partially flat 20 and partially diagonal 21, a plurality of elongated springs 14 illustrated FIG. 2 in which one extreme 15 of each elongated spring 14 is jointed to the holder body 7 and the other extreme 17 is rejecting the electrical connectors' holder 22, wherein a barrier 10 within the holder body 7 is preventing the tooth 18 to be unlocked by blocking the flat portion side 20 of the tooth 18, only if the elongated springs 14 are bent by pushing the electrical connectors' holder 22, the flat portion 20 of the tooth 18 passing by the barrier 10 and the tooth 18 being freed to be unlocked, therefore the partial diagonal side 21 climbs up the unlocking slope 9.

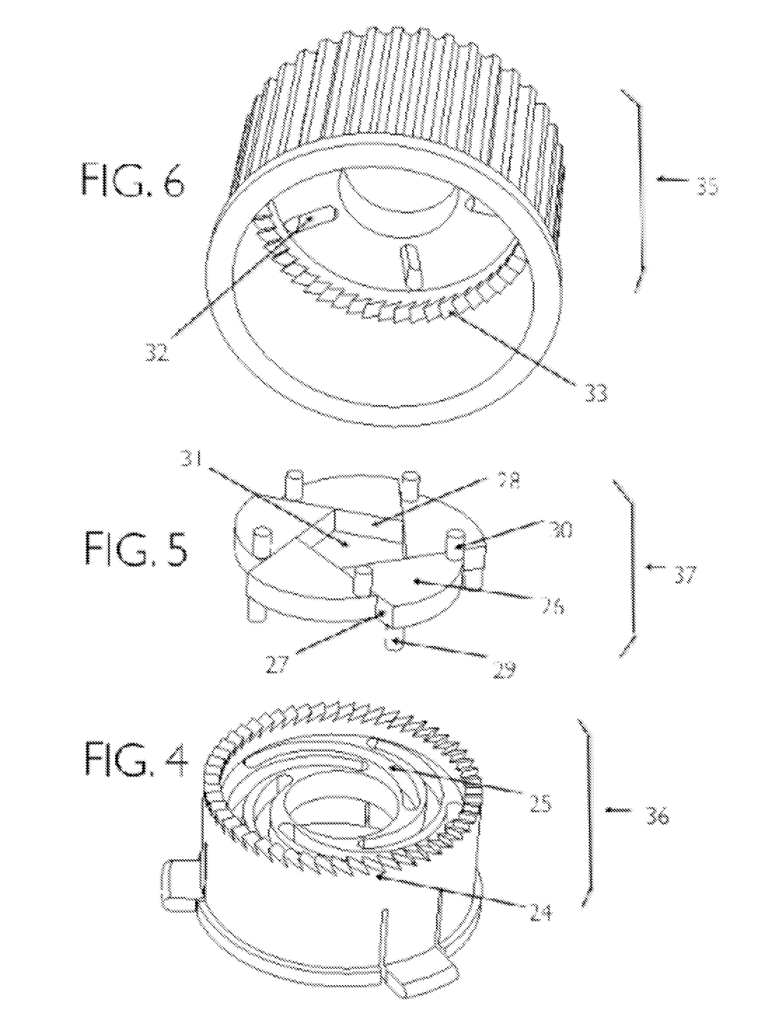

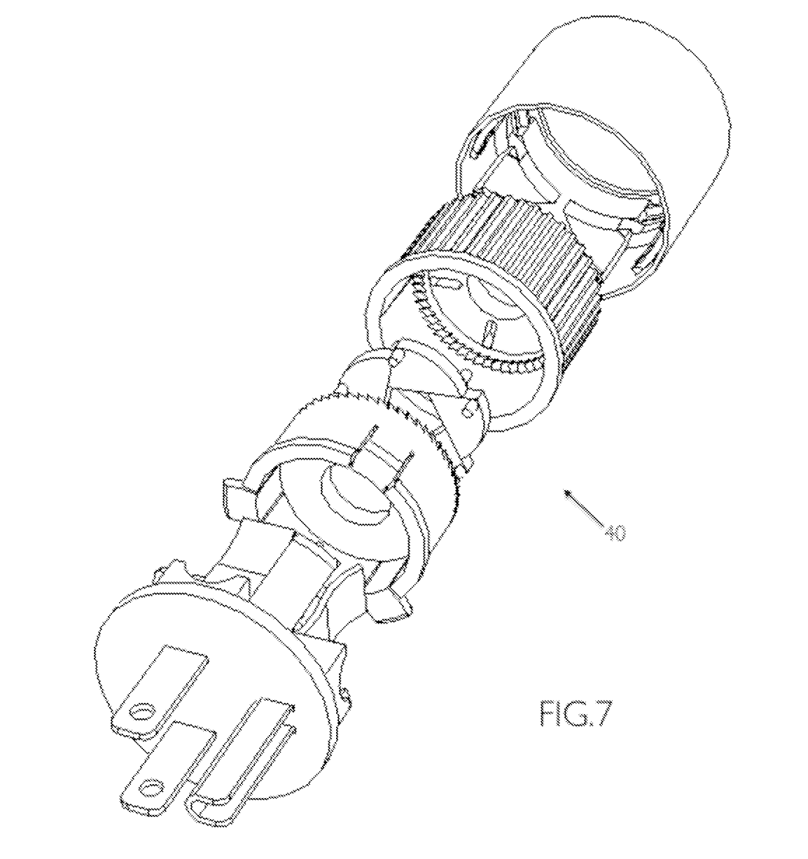

With reference to FIG. 4, FIG. 5 and FIG. 6 shows a space adjuster mechanism used for the improved electrical plug 40 FIG. 7 to fasten up a cable, where commonly the plugs are coupled, wherein a plurality of petals 26 concentrically and uniformly arranged are sliding one over another, in which each side (B) 27 of each petal 26 is mounted over each side (A) 28 of the next petal 26, each petal 26 having a guide pin 29 coupled into a guide slot 25 within the concentrical guide 36, each petal 26 having a motion pin 30 coupled into a motion slot 32 within the motion transmitter 35, wherein while the motion transmitter 35 is rotating drives simultaneously via motion slots 32 all the petals 26, of the concentrical flower 37, the guide pins 29 moving one extreme of each petal 26 toward the axis and the other extreme of each petal 26 is moved for the motion slot 32 outward the axis, so each petal 26 sliding one over another, therefore adjusting the hole's size 31 among all the petals 26 of the concentrical flower 37 and this adjustment is keep by the plurality of concentrical teeth 24 of the concentrical guide 36 engaged to the plurality of concentrical teeth of the motion transmitter 35, to tighten up a cable.

1. An improved electrical plug for electrically operated devices having a plurality of electrical connectors, an electrical connectors' holder, a plug's cover, a cable fastener, said improved electrical plug comprising a line attacher coupled to each electrical connectors,
wherein the line attacher comprising:
a) a hook having an elongated arm, the hook hanging into a cavity of the electrical connectors' holder, said cavity matching at least part of the curvature of the hook; and
b) a line holder adjacent to the cavity, wherein the elongated arm motioning the hook therefore the hook coupling into the cavity pressing the line holder.

2. The improved electrical plug of claim 1, in which the line holder has an elongation, said elongation matching at least part of the curvature of the hook, therefore the hook coupling into the line holder.

3. The improved electrical plug of claim 1, further comprising a locking and unlocking mechanism for securing the plug's cover to the electrical connectors' holder,
wherein the locking and unlocking mechanism comprising:
a) a complex of passages and slopes within a holder body, having at least a main passage, a locking slope adjacent to one extreme of said main passage, at least on one lateral side of said locking slope, adjacent an unlocking slope and an exit passage leading to the main passage;
b) a component having a tooth passing through the main passage of the holder body, wherein the said tooth being projected to the locking slope, therefore the said tooth being locked behind the locking slope positioning adjacent to the unlocking slope.

4. The improved electrical plug of claim 1, in which the locking and unlocking mechanism further comprising an unlocking preventer mechanism, in which at least a lateral side of the tooth being a section flat and a section diagonal for climbing the unlocking slope,
wherein the unlocking preventer mechanism comprising:
a) a plurality of elongated springs matching the surface of the holder body, wherein one extreme of each elongated spring is joined to the holder body and the other extreme rejecting the electrical connectors' holder; and
b) a barrier within the holder body, being adjacent to the locking slope, said barrier blocking the flat section of the lateral side of the tooth.

5. The improved electrical plug of claim 1, further comprising a space adjuster mechanism within the cable fastener, for adjusting the hole size among the cable fastener and tightening a cable,
wherein the space adjuster mechanism comprising:
a) a concentrical guide having at least three guide slots concentrically arranged to an axis and a plurality of teeth concentrically arranged to the axis, wherein one extreme of each guide slots projected outward the axis and the other extreme of each guide slots projected toward the axis;
b) a plurality of petals, said petals being components concentrically and uniformly arranged to the axis, each petal having a side (A) similar to an adjacent side (B), wherein the side (A) projected to the axis and each petal's side (B) mounted over another petal's side (A), one extreme of each petal pivotally connected to each guide slot; and
c) a motion transmitter, having at least three motion slots and a plurality of concentrical teeth engaged to the plurality of concentrical teeth of the concentrical guide, each motion slot pivotally coupled to the other extreme of each petal, wherein the motion transmitter motioning the petals by the motion slots, one extreme of each petal moving toward the axis by the guide slots and the other extreme of each petal moving outward the axis by the motion slots, adjusting the volume magnitude among all the petals.

6. A line attacher having a support body, for attaching all kind of lines, said line attacher comprising:
a) a hook having an elongated arm, said hook hanging into a cavity of the support body; and
b) a line holder adjacent to the cavity of the support body, said cavity matching at least part of the curvature of the hook wherein the hook's elongated arm motioning the hook therefore the hook coupling into the cavity pressing the line holder.

7. The line attacher of claim 6, in which the line holder has an elongation, said elongation matching at least part of the curvature of the hook, therefore the hook coupling into the line holder.

8. A locking and unlocking mechanism for attachers the kind securing coupled bodies, having a holder body, a component with a tooth, said locking and unlocking mechanism comprising:
a) a complex of passages and slopes within the holder body, having at least a main passage, a locking slope adjacent to one extreme of said main passage, at least on one lateral side of said locking slope, adjacent an unlocking slope and an exit passage leading to the main passage; and
b) a component having a tooth passing through the main passage of the holder body, wherein the said tooth being projected to the locking slope, therefore the said tooth being locked behind the locking slope positioning adjacent to the unlocking slope.

9. The locking and unlocking mechanism of claim 8, in which the locking and unlocking mechanism further comprising an unlocking preventer mechanism, in which at least a lateral side of the tooth being a section flat and a section diagonal for climbing the unlocking slope,
wherein the unlocking preventer mechanism comprising:
a) a plurality of elongated springs matching the surface of the holder body, wherein one extreme of each elongated spring is joined to the holder body and the other extreme rejecting the electrical connectors' holder; and
b) a barrier within the holder body, being adjacent to the locking slope, said barrier blocking the flat section of the lateral side of the tooth.

10. A space adjuster mechanism for adjusting and even eliminating the volume magnitude among concentrical movable surfaces for ducts and passages, the space adjuster mechanism comprising:
a) a concentrical guide having at least three guide slots concentrically arranged to an axis and a plurality of teeth concentrically arranged to the axis, wherein one extreme of each guide slots projected outward the axis and the other extreme of each guide slots projected toward the axis;
b) a plurality of petals, said petals being components concentrically and uniformly arranged to the axis, each petal having a side (A) similar to an adjacent side (B), wherein the side (A) projected to the axis and each petal's side (B) mounted over another petal's side (A), one extreme of each petal pivotally connected to a guide slot; and
c) a motion transmitter, having at least three motion slots and a plurality of concentrical teeth engaged to the plurality of concentrical teeth of the concentrical guide, each motion slot pivotally coupled to the other extreme of each petal, wherein the motion transmitter motioning the petals by the motion slots, one extreme of each petal moving toward the axis by the guide slots and the other extreme of each petal moving outward the axis by the motion slots, adjusting the volume magnitude among all the petals.
